(19) United States
(12) Patent Application Publication
(10) Pub. No.: US 2011/0225545 A1
(43) Pub. Date: Sep. 15, 2011

(54) SYSTEM AND METHOD OF DISPLAYING GRAPHICAL USER INTERFACE OBJECTS

(76) Inventors: Samuel J. Horodezky, San Diego, CA (US); Kam-Cheong Anthony Tsoi, San Diego, CA (US); Kathleen M. Bruce, San Diego, CA (US)

(21) Appl. No.: 12/750,934

(22) Filed: Mar. 31, 2010

Related U.S. Application Data
(60) Provisional application No. 61/312,117, filed on Mar. 9, 2010.

(51) Int. Cl. G06F 3/048

(52) U.S. Cl. 715/810

(57) ABSTRACT

A method of displaying graphical user interface objects is disclosed and may include displaying a GUI object menu on a display and displaying a wrinkled portion at at least one an end of the GUI object menu. The wrinkle indicator may indicate that one or more GUI objects are available off screen at an edge of the display adjacent to the wrinkle indicator.

### RELATED APPLICATIONS

The present application claims priority to and incorporates by reference U.S. Provisional Patent Application Ser. No. 61/312,117, entitled SYSTEM AND METHOD OF DISPLAYING GRAPHICAL USER INTEFACE OBJECTS, filed on Mar. 9, 2010.

### DESCRIPTION OF THE RELATED ART

Portable computing devices (PDs) are ubiquitous. These devices may include cellular telephones, portable digital assistants (PDAs), portable game consoles, palmtop computers, and other portable electronic devices. Many portable computing devices include a touch screen interface in which a user may interact with the device and input commands. Further, the touch screen interface may be used to display multiple items, e.g., application icons, thumbnails, tiles, or a combination thereof. Many displays include scrolling functionality as a way to navigate through the items and locate specific items. Oftentimes, the scrolling functionality may cumbersome and difficult to use.

Accordingly, what is needed is an improved method of displaying graphical user interface objects on a touchscreen user interface.

### BRIEF DESCRIPTION OF THE DRAWINGS

In the figures, like reference numerals refer to like parts throughout the various views unless otherwise indicated.

FIG. 1 is a front plan view of a first aspect of a portable computing device (PCD) in a closed position;

FIG. 2 is a front plan view of the first aspect of a PCD in an open position;

FIG. 3 is a block diagram of a second aspect of a PCD;

FIG. 4 is a first portion of a flowchart illustrating a method of displaying graphical user interface objects;

FIG. 5 is a second portion of a flowchart illustrating a method of displaying graphical user interface objects;

FIG. 6 is a third portion of a flowchart illustrating a method of displaying graphical user interface objects;

FIG. 7 is a fourth portion of a flowchart illustrating a method of displaying graphical user interface objects;

FIG. 8 is a fifth portion of a flowchart illustrating a method of displaying graphical user interface objects;

FIG. 9 is a sixth portion of a flowchart illustrating a method of displaying graphical user interface objects;

FIG. 10 is a seventh portion of a flowchart illustrating a method of displaying graphical user interface objects;

FIG. 11 is an eighth portion of a flowchart illustrating a method of displaying graphical user interface objects;

FIG. 12 is a first plan view of a graphical user interface object menu;

FIG. 13 is a second plan view of the graphical user interface object menu;

FIG. 14 is a first detailed view of a graphical user interface object menu;

FIG. 15 is a third plan view of the graphical user interface object menu;

FIG. 16 is a second detailed view of a graphical user interface object menu;

FIG. 17 is a fourth plan view of the graphical user interface object menu;

FIG. 18 is a third detailed view of a graphical user interface object menu;

FIG. 19 is a fifth plan view of the graphical user interface object menu;

FIG. 20 is a fourth detailed view of a graphical user interface object menu;

FIG. 21 is a sixth plan view of the graphical user interface object menu;

FIG. 22 is a fifth detailed view of a graphical user interface object menu;

FIG. 23 is a seventh plan view of the graphical user interface object menu;

FIG. 24 is an eight plan view of the graphical user interface object menu;

FIG. 25 is a ninth plan view of the graphical user interface object menu;

FIG. 26 is a tenth plan view of the graphical user interface object menu;

FIG. 27 is a eleventh plan view of the graphical user interface object menu;

FIG. 28 is a twelfth plan view of the graphical user interface object menu;

FIG. 29 is a thirteenth plan view of the graphical user interface object menu; and

FIG. 30 is a fourteenth plan view of the graphical user interface object menu.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

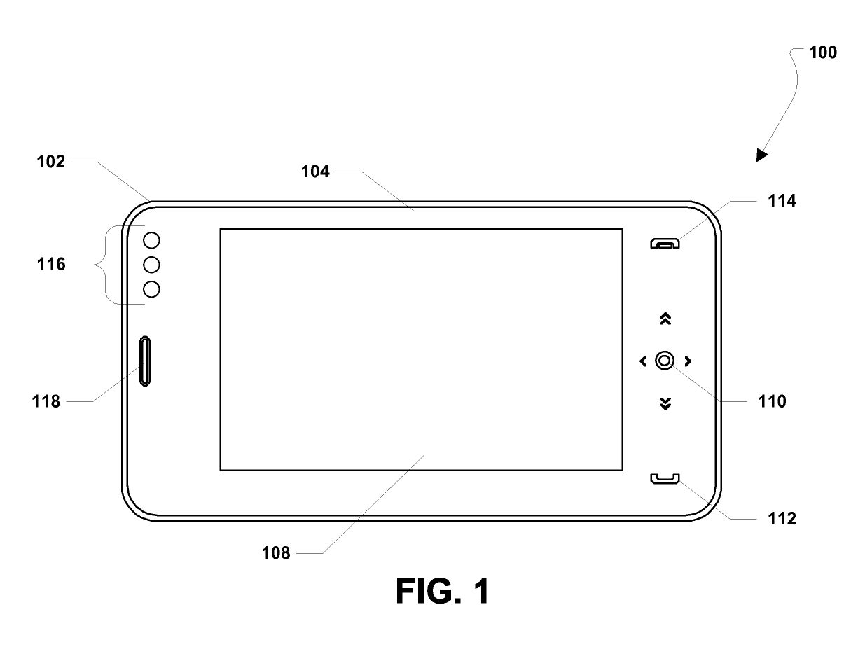

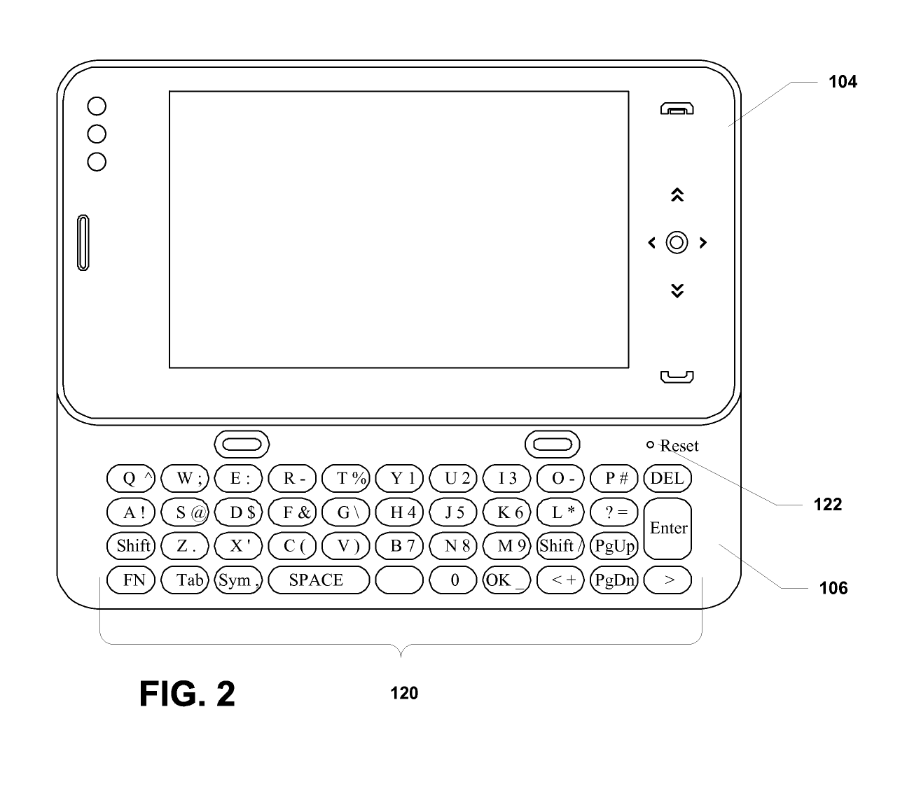

Referring initially to FIG. 1 and FIG. 2, an exemplary portable computing device (PCD) is shown and is generally designated 100. As shown, the PCD 100 may include a housing 102. The housing 102 may include an upper housing portion 104 and a lower housing portion 106. FIG. 1 shows that the upper housing portion 104 may include a display 108. In a particular aspect, the display 108 may be a touch screen display. The upper housing portion 104 may also include a trackball input device 110. Further, as shown in FIG. 1, the upper housing portion 104 may include a power on button 112 and a power off button 114. As shown in FIG. 1, the upper housing portion 104 of the PCD 100 may include a plurality of indicator lights 116 and a speaker 118. Each indicator light 116 may be a light emitting diode (LED).

In a particular aspect, as depicted in FIG. 2, the upper housing portion 104 is movable relative to the lower housing portion 106. Specifically, the upper housing portion 104 may be slidable relative to the lower housing portion 106. As shown in FIG. 2, the lower housing portion 106 may include a multi-button keyboard 120. In a particular aspect, the multi-button keyboard 120 may be a standard QWERTY keyboard. The multi-button keyboard 120 may be revealed when the upper housing portion 104 is moved relative to the lower housing portion 106. FIG. 2 further illustrates that the PCD 100 may include a reset button 122 on the lower housing portion 106.

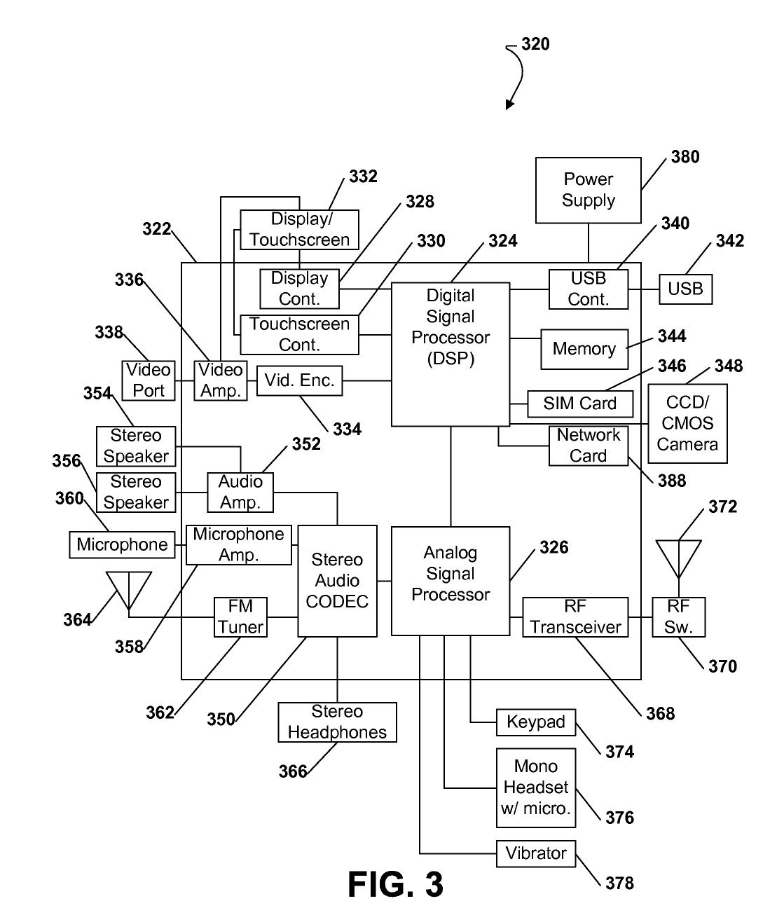

Referring to FIG. 3, an exemplary, non-limiting aspect of a portable computing device (PCD) is shown and is generally designated 320. As shown, the PCD 320 includes an on-chip system 322 that includes a digital signal processor 324 and an analog signal processor 326 that are coupled together. The on-chip system 322 may include more than two processors. For example, the on-chip system 322 may include four core processors and an ARM 11 processor, i.e., as described below in conjunction with FIG. 32.

As illustrated in FIG. 3, a display controller 328 and a touch screen controller 330 are coupled to the digital signal processor 324. In turn, a touch screen display 332 external to the on-chip system 322 is coupled to the display controller 328 and the touch screen controller 330.

FIG. 3 further indicates that a video encoder 334, e.g., a phase alternating line (PAL) encoder, a sequential couleur a memoire (SECAM) encoder, or a national television system(s) committee (NTSC) encoder, is coupled to the digital signal processor 324. Further, a video amplifier 336 is coupled to the video encoder 334 and the touch screen display 332. Also, a video port 338 is coupled to the video amplifier 336. As depicted in FIG. 3, a universal serial bus (USB) controller 340 is coupled to the digital signal processor 324. Also, a USB port 342 is coupled to the USB controller 340. A memory 344 and a subscriber identity module (SIM) card 346 may also be coupled to the digital signal processor 324. Further, as shown in FIG. 3, a digital camera 348 may be coupled to the digital signal processor 324. In an exemplary aspect, the digital camera 348 is a charge-coupled device (CCD) camera or a complementary metal-oxide semiconductor (CMOS) camera.

As further illustrated in FIG. 3, a stereo audio CODEC 350 may be coupled to the analog signal processor 326. Moreover, an audio amplifier 352 may coupled to the stereo audio CODEC 350. In an exemplary aspect, a first stereo speaker 354 and a second stereo speaker 356 are coupled to the audio amplifier 352. FIG. 3 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 3 further indicates that a radio frequency (RF) transceiver 368 may be coupled to the analog signal processor 326. An RF switch 370 may be coupled to the RF transceiver 368 and an RF antenna 372. As shown in FIG. 3, a keypad 374 may be coupled to the analog signal processor 326. Also, a mono headset with a microphone 376 may be coupled to the analog signal processor 326. Further, a vibrator device 378 may be coupled to the analog signal processor 326. FIG. 3 also shows that a power supply 380 may be coupled to the on-chip system 322. In a particular aspect, the power supply 380 is a direct current (DC) power supply that provides power to the various components of the PCD 320 that require power. Further, in a particular aspect, the power supply is a rechargeable DC battery or a DC power supply that is derived from an alternating current (AC) to DC transformer that is connected to an AC power source.

FIG. 3 further indicates that the PCD 320 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, or any other network card well known in the art. Further, the network card 388 may be incorporated into a chip, i.e., the network card 388 may be a full solution in a chip, and may not be a separate network card 388.

As depicted in FIG. 3, the touch screen display 332, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 are external to the on-chip system 322.

In a particular aspect, one or more of the method steps described herein may be stored in the memory 344 as computer program instructions. These instructions may be executed by a processor 324, 326 in order to perform the methods described herein. Further, the processors 324, 326, the memory 344, the display controller 328, the touch screen controller 330, or a combination thereof may serve as a means for executing one or more of the method steps described herein in order to display graphical user interface objects at the display/touch screen 332.

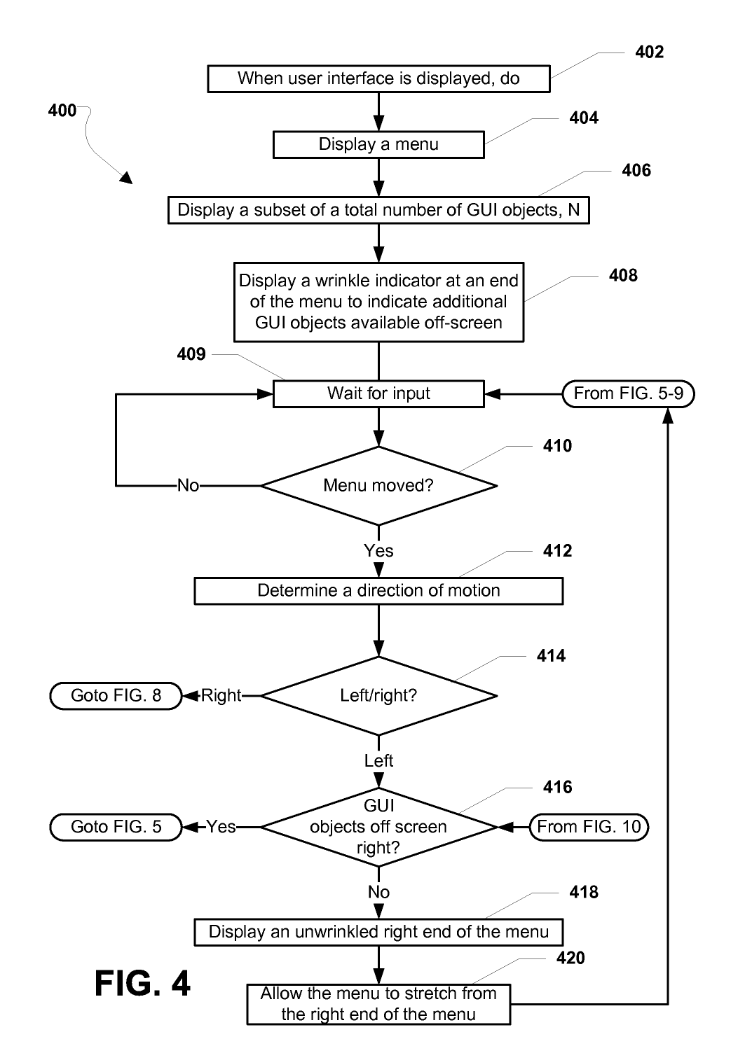

Referring to FIG. 4 through FIG. 11, a method of displaying user interface objects at a display is shown and is generally designated 400. The method 400 may commence at block 402 of FIG. 4 with a do loop in which when user interface is displayed, the following steps may be performed, e.g., by a display controller. At block 404, the controller may display a GUI object menu. Next, at block 406, the controller may display a subset of a total number of GUI objects, N, in the GUI object menu. At block 408, the controller may display a wrinkle indicator, e.g., a wrinkled portion, at an end of the GUI object menu to indicate additional GUI objects available off screen. The wrinkle indicator may be at the left end of the GUI object menu, at the right end of the GUI object menu, or a combination thereof. From block 408, the method 400 may continue to block 409 and the controller may wait for an input from a user, e.g., movement of the GUI object menu to the left or to the right. In other words, the controller may monitor the GUI object menu in order to detect whether the GUI object menu is moved in either direction.

Moving to decision 410, the controller may determine whether the menu moved, e.g., left or right, up or down, one corner to another corner, etc. For ease of discussion, the method 400 is only described in terms of left-to-right or right-to-left movement. It may be appreciated that by replacing left and right with up and down, or other paired-directional indicators, the method 400 may be applied to other types of linear movement in opposite directions.

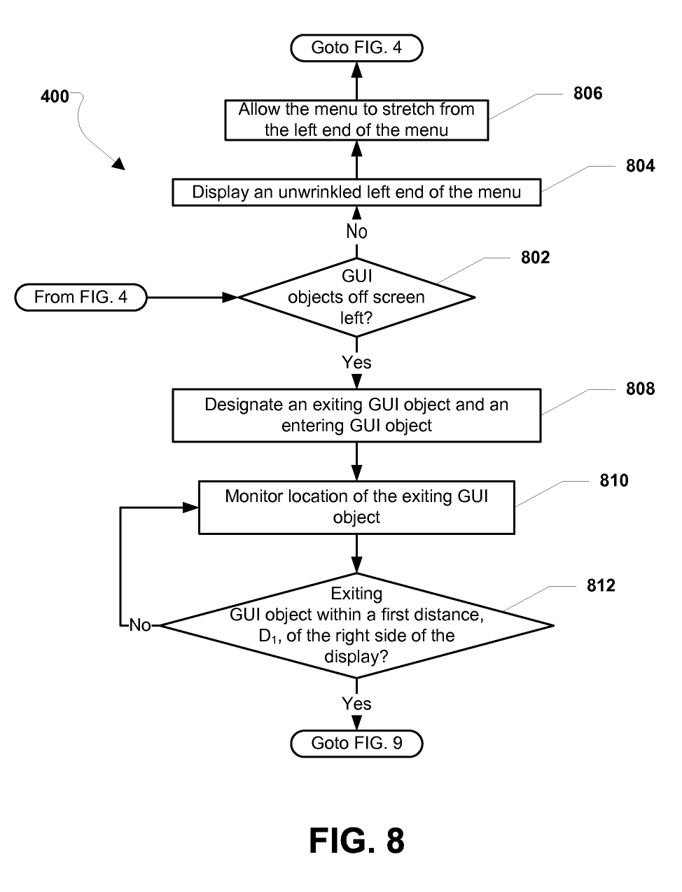

Returning to decision 410, if the menu is not moved, the method 400 may return to block 409 and the method 400 may continue as described herein. If the menu is moved, the method 400 may proceed to block 412 and the controller may determine a direction of motion. In a particular aspect, the direction of motion may be a first direction or a second direction. Further, the first direction of motion and the second direction of motion may be in opposite directions. For example, at decision 414, the controller may determine whether the direction of motion is to the left or to the right. If the direction of motion is to the right, i.e., a first direction, the method 400 may proceed directly to decision 802 of FIG. 8.

On the other hand, if the direction of motion is to the left, a second direction, the method 400 may proceed to decision 416 and the controller may determine whether there are any GUI objects off screen to the right. If there are not any GUI objects off screen to the right, the method 400 may continue to block 418 and the controller may display an unwrinkled right end of the menu. Thereafter, at block 420, the controller may allow the menu to stretch from the right end of the menu. Then, the method 400 may return to block 409 and the method 400 may continue as described herein.

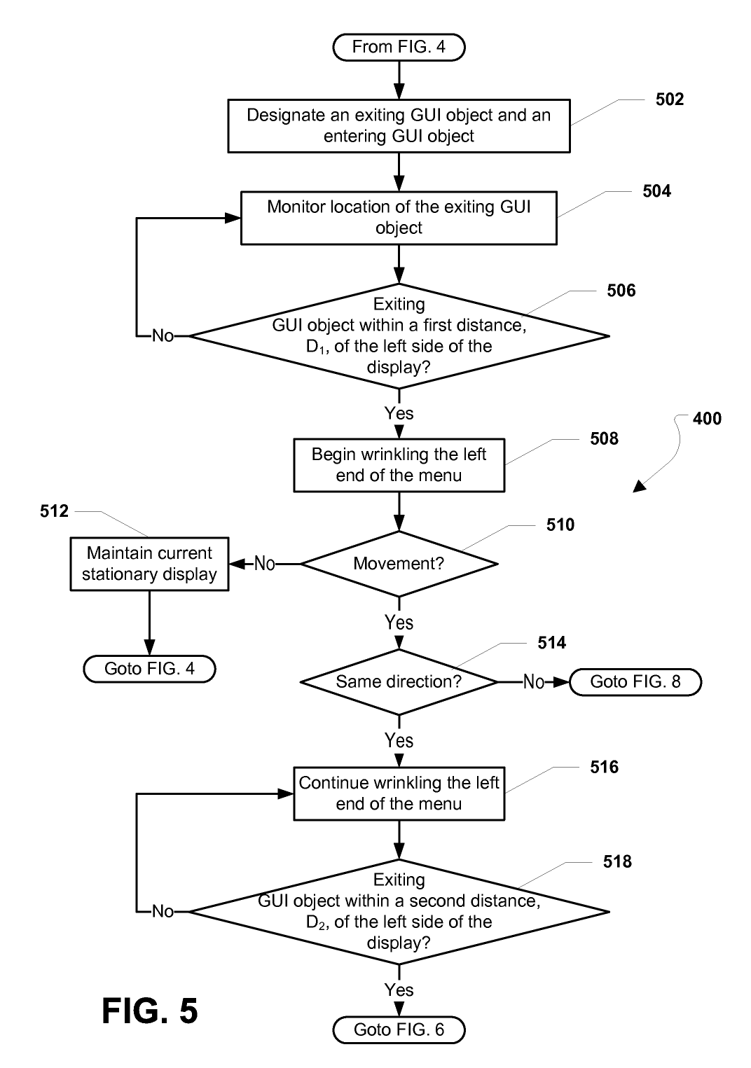

Returning to decision 416, if there are GUI objects off screen to the right, the method 400 may move to block 502 of FIG. 5. At block 502 of FIG. 5, the controller may designate a GUI object that is nearest the left end of the menu as an exiting GUI object and the controller may designate a GUI object that is immediately off screen to the right as an entering GUI object. At block 504, the controller may monitor a location of the exiting GUI object. Moreover, at decision 506, the controller may determine whether an exiting GUI object is within a first distance, D₁, of the left side, or left edge, of the display. If not, the method 400 may return to block 504 and the method 400 may continue as described herein.

Conversely, if the exiting GUI object is within the first distance, D₁, of the left side of the display, the method 400 may move to block 508 and the controller may begin wrinkling the left end of the GUI object menu. Next, at decision 510, the controller may determine whether there is continued movement of the GUI object menu. If not, the method 400 may move to block 512, and the controller may maintain current stationary display. Then, the method 400 may return to block 409 of FIG. 4 and the method 400 may continue as described herein.

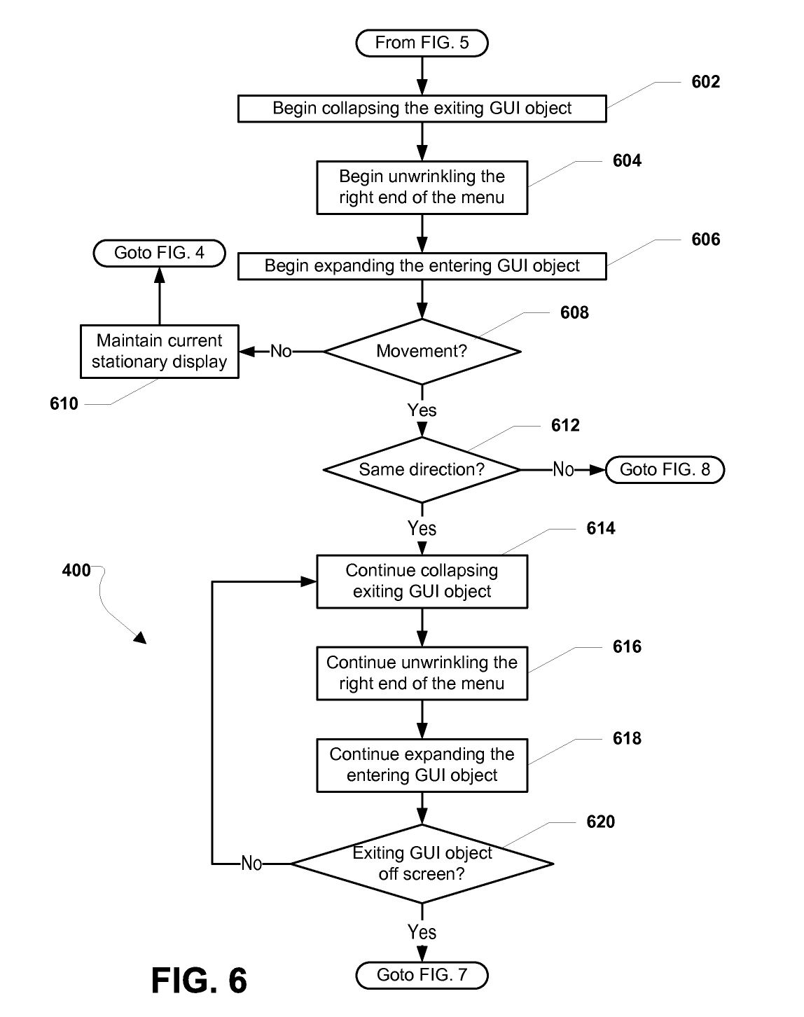

Returning to decision 510, if there is continued movement of the GUI object menu, the method 400 may continue to decision 514 and the controller may determine whether the movement of the GUI object menu is in the same direction as the previous motion. If not, the method 400 may move directly to decision 802 of FIG. 8 and the method 400 may continue as described herein. If the movement of the GUI object menu is in the same direction as the previous movement of the GUI object menu, the method 400 may move to block 516 and the controller may continue wrinkling the left end of the GUI object menu. Next, at decision 518, the controller may determine whether the exiting GUI object is within a second distance, D₂, of the left side, or left edge, of the display. If the GUI object is not within the second distance of the left end of the toolbar, the method 400 may return to block 516. Otherwise, the method 400 may move to block 602 of FIG. 6.

At block 602 of FIG. 6, the controller may begin collapsing the exiting GUI object. At block 604, the controller may begin unwrinkling the right end of the GUI object menu. Also, at block 606, the controller may begin expanding an entering GUI object, i.e., a GUI object that is entering the GUI object menu, from off screen to the right. At decision 608, the controller may determine whether there is continued movement, or motion, of the GUI object menu. If not, the method 400 may move to block 610 and the controller may maintain current stationary display. Then, the method 400 may return to block 409 of FIG. 4 and the method 400 may proceed as described herein.

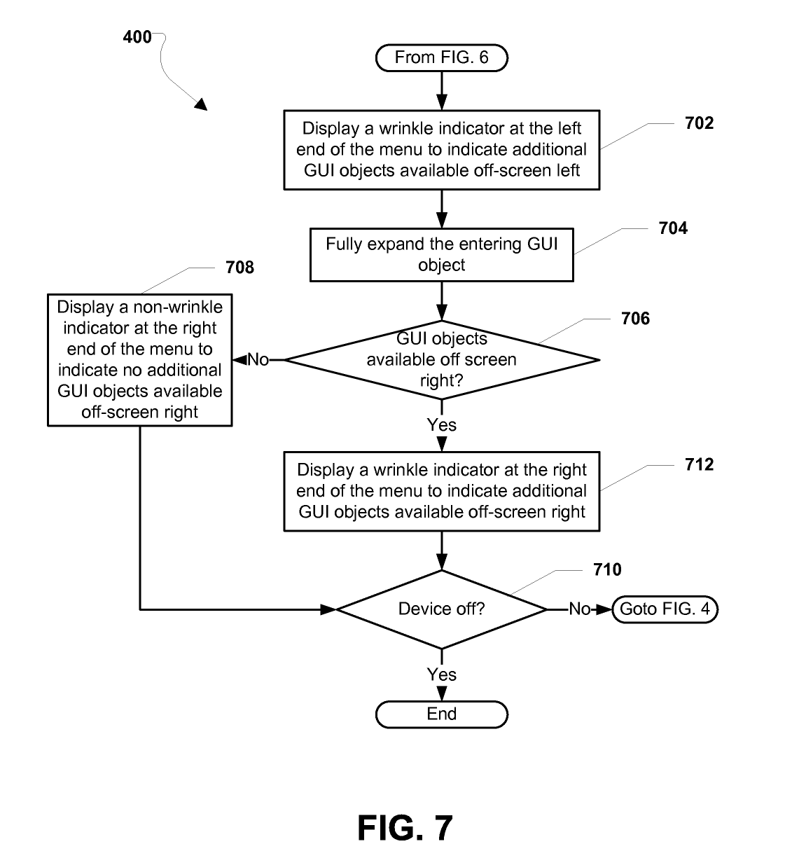

Returning to decision 608, if there is continued movement of the GUI object menu, the method 400 may move to decision 612 and the controller may determine whether the movement is in the same direction as the previous movement of the GUI object menu. If not, the method 400 may move directly to decision 802 of FIG. 8 and the method 400 may continue as described herein. On the other hand, if the movement is in the same direction as the previous movement, or motion, the method 400 may continue to block 614 and the controller may continue collapsing the exiting GUI object. At block 616, the controller may continue unwrinkling the right end of the GUI object menu. Further, at block 618, the controller may continue expanding the entering GUI object. At decision 620, the controller may determine whether the exiting GUI object is completely off screen, i.e., it has moved off of the display to the left. If not, the method 400 may return to block 614 and the method 400 may continue as described herein. Otherwise, if the exiting GUI object is off screen, the method 400 may proceed to block 702 of FIG. 7.

At block 702 of FIG. 7, the controller may display a wrinkle indicator, e.g., a wrinkled portion, at the left end of the GUI object menu to indicate additional GUI objects available off screen left. Further, at block 704, the controller may fully expand the entering GUI object. Moving to decision 706, the controller may determine whether there are more GUI objects available off screen to the right. If not, the method 400 may proceed to block 708 and the controller may display a non-wrinkle indicator, e.g., an unwrinkled portion, at the right end of the GUI object menu to indicate no additional GUI objects are available off screen to the right. Next, at decision 710, the controller may determine whether the device is powered off. If so, the method 400 may end. Conversely, if the device remains powered on, the method 400 may return to block 409 of FIG. 4.

Returning to decision 706, if more GUI objects are available off screen to the right, the method 400 may move to block 712 and the controller may display a wrinkle indicator at the right end of the GUI object menu to indicate that there are additional GUI objects available off screen to the right. From block 712, the method 400 may continue to decision 710 and the method 400 may continue as described herein.

Returning to decision 414 of FIG. 4, if the direction of motion, or movement, of the GUI object menu is to the right, the method 400 may move to decision 802 of FIG. 8.

At decision 802 of FIG. 8, the controller may determine whether there are any GUI objects off screen to the left. If there are not any GUI objects off screen to the left, the method 400 may continue to block 804 and the controller may display an unwrinkled left end of the menu. Thereafter, at block 806, the controller may allow the menu to stretch from the left end of the menu. Then, the method 400 may return to block 409 of FIG. 4, and the method 400 may continue as described herein.

Returning to decision 802, if there are GUI objects off screen to the left, the method 400 may move to block 808. At block 808, the controller may designate a GUI object that is nearest the right end of the menu as an exiting GUI object and the controller may designate a GUI object that is immediately off screen to the left as an entering GUI object. At block 810, the controller may monitor a location of the exiting GUI object. Moreover, at decision 812, the controller may determine whether an exiting GUI object is within a first distance, D₁, of the right side, or right edge, of the display. If not, the method 400 may return to block 810 and the method 400 may continue as described herein.

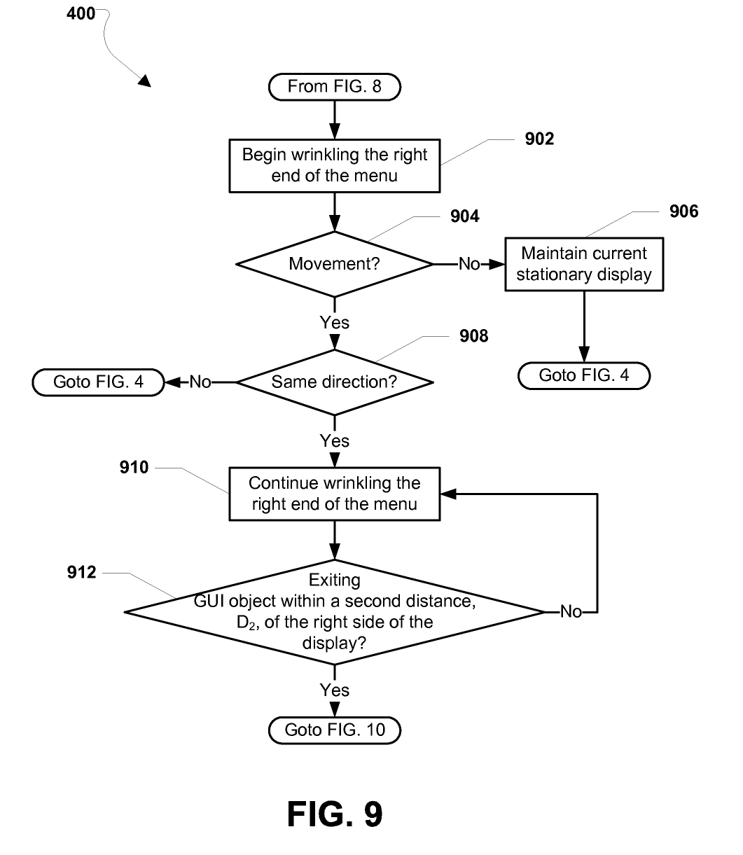

Conversely, if the exiting GUI object is within the first distance, D₁, of the right side of the display, the method 400 may move to block 902 of FIG. 9. At block 902 of FIG. 9, the controller may begin wrinkling the right end of the GUI object menu. Next, at decision 904, the controller may determine whether there is continued movement of the GUI object menu. If not, the method 400 may move to block 906, and the controller may maintain current stationary display. Then, the method 400 may return to block 409 of FIG. 4 and the method 400 may continue as described herein.

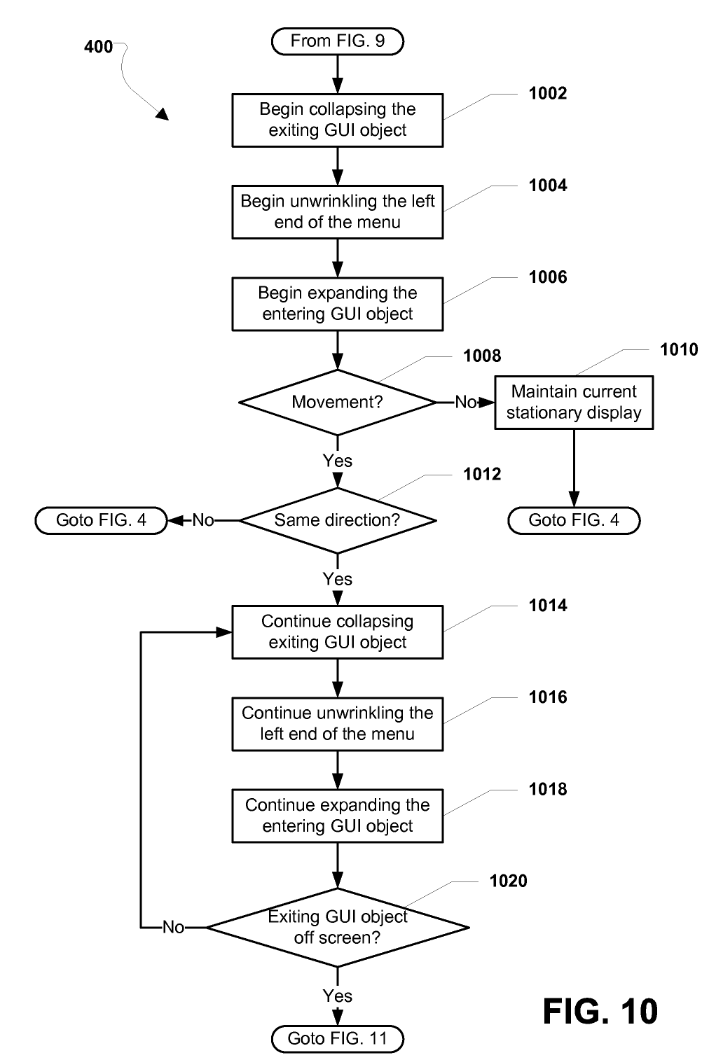

Returning to decision 904, if there is continued movement of the GUI object menu, the method 400 may continue to decision 908 and the controller may determine whether the movement of the GUI object menu is in the same direction as the previous motion. If not, the method 400 may return to decision 416 of FIG. 4 and the method 400 may continue as described herein. If the movement of the GUI object menu is in the same direction as the previous movement of the GUI object menu, the method 400 may move to block 910 and the controller may continue wrinkling the right end of the GUI object menu. Next, at decision 912, the controller may determine whether the exiting GUI object is within a second distance, D₂, of the right side, or right edge, of the display. If not, the method 400 may return to block 910 and continue as described herein. Otherwise, the method 400 may proceed to block 1002 of FIG. 10.

At block 1002 of FIG. 10, the controller may begin collapsing the exiting GUI object. At block 1004, the controller may begin unwrinkling the left end of the GUI object menu. Also, at block 1006, the controller may begin expanding an entering GUI object, i.e., a GUI object that is entering the GUI object menu from off screen to the left. At decision 1008, the controller may determine whether there is continued movement, or motion, of the GUI object menu. If not, the method 400 may move to block 1010 and the controller may maintain current stationary display. Then, the method 400 may return to block 409 of FIG. 4 and the method 400 may proceed as described herein.

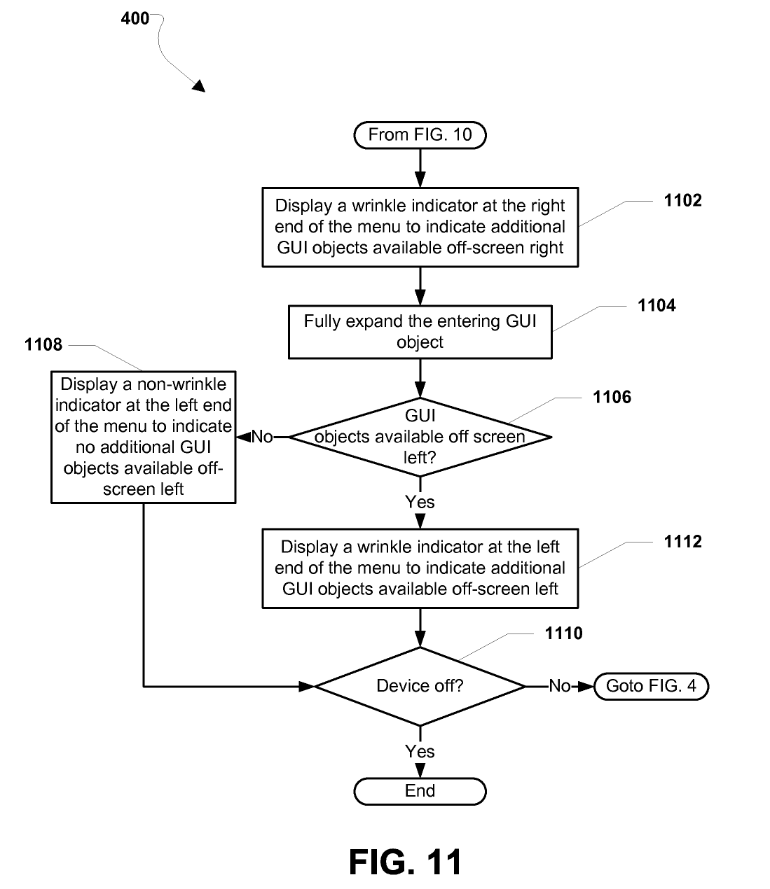

Returning to decision 1008, if there is continued movement of the GUI object menu, the method 400 may move to decision 1012 and the controller may determine whether the movement is in the same direction as the previous movement of the GUI object menu. If not, the method 400 may move directly to decision 416 of FIG. 4 and the method 400 may continue as described herein. On the other hand, if the movement is in the same direction as the previous movement, or motion, the method 400 may continue to block 1014 and the controller may continue collapsing the exiting GUI object. At block 1016, the controller may continue unwrinkling the left end of the GUI object menu. Further, at block 1018, the controller may continue expanding the entering GUI object. Next, at decision 1020, the controller may determine whether the exiting GUI object is completely off screen, i.e., it has moved off of the display to the right. If not, the method 400 may return to block 1014 and the method 400 may continue as described herein. Otherwise, if the exiting GUI object is off screen, the method 400 may proceed to block 1102 of FIG. 11.

At block 1102 of FIG. 11, the controller may display a wrinkle indicator at the right end of the GUI object menu to indicate additional GUI objects available off screen right. Further, at block 1104, the controller may fully expand the entering GUI object. Moving to decision 1106, the controller may determine whether there are more GUI objects available off screen to the left. If not, the method 400 may move to block 1108 and the controller may display a non-wrinkle indicator at the left end of the GUI object menu to indicate no additional GUI objects are available off screen to the left. Next, at decision 1110, the controller may determine whether the device is powered off. If so, the method 400 may end. Conversely, if the device remains powered on, the method 400 may return to block 409 of FIG. 4.

Returning to decision 1106, if more GUI objects are available off screen to the right, the method 400 may move to block 1112 and the controller may display a wrinkle indicator at the left end of the GUI object menu to indicate that there are additional GUI objects available off screen to the left. From block 1112, the method 400 may continue to decision 1110 and the method 400 may continue as described herein.

In a particular aspect, as described herein, the method may utilize a first predetermined distance from a left side of a display, a second predetermined distance from a left side of a display, a first predetermined distance from a right side of a display, and a second predetermined distance from a right side of a display in conjunction with an exiting GUI object in order to trigger the formation of a wrinkled portion and the collapsing of a GUI object. It may be appreciated, that other distances to the sides of the display may be used to trigger other actions relating to the GUI object menu and the GUI objects.

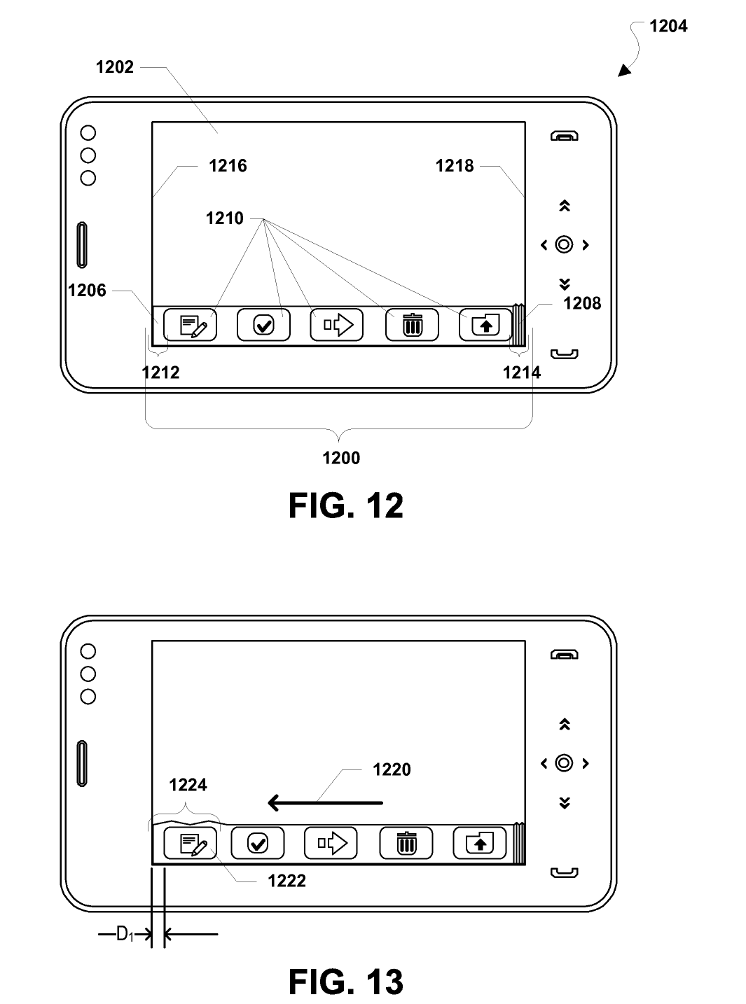

Referring now to FIG. 12, a graphical user interface (GUI) object menu is shown and is generally designated 1200. As shown, the GUI object menu 1200 may be displayed on a display 1202 of a portable computing device (PCD) 1204. The GUI object menu 1200 may include a left end 1206 and a right end 1208. Further, the GUI object menu 1200 may include one or more GUI objects 1210. In a particular aspect, each GUI object 1210 may be an icon, a thumbnail, or a combination thereof. Also, each GUI object 1210 may represent an application, a file, a web page, or a combination thereof. Further, the GUI object menu may include a single row of GUI objects 1210, as shown, or multiple rows of GUI objects 1210.

As shown in FIG. 12, the left end 1206 of the GUI object menu 1200 include an unwrinkled portion 1212 in order to indicate that there are not any GUI objects available off screen to the left of the display 1202. Further, the right end 1208 of the GUI object menu 1200 may include a wrinkled portion 1214 in order to indicate that there are GUI objects available off screen to the right of the display 1202. As further indicated in FIG. 12, the display 1202 may include a left side 1216 and a right side 1218.

During operation, the GUI object menu 1200 may be moved to the left and right if GUI objects are available off screen on opposite sides of the attempted direction of motion. For example, if there are not any GUI objects available off screen to the left as indicated by the unwrinkled portion 1212 of the left end 1206 of the GUI object menu 1200 and a user attempts to move the GUI object menu 1200 to the right, the left end 1206 of the GUI object menu 1200 may stretch and return to a starting position as if the left end 1206 of the GUI object menu 1200 is elastic.

On the other hand, if there are GUI objects available off screen to the right, as indicated by the wrinkled portion 1214 of the right end 1208 of the GUI object menu 1200, the GUI object menu may be moved to the left as indicated by arrow 1220 in FIG. 13. Further, as the GUI object menu is moved to the left, the GUI object 1210 that is closest to the left side of the display 1202 may be designated as an exiting GUI object 1222. As shown in FIG. 13, when the exiting GUI object 1222 is within a first predetermined distance, D₁, of the left side 1216 of the display 1202, the left end 1206 of the GUI object menu 1200 may begin to form an initial wrinkled portion 1224.

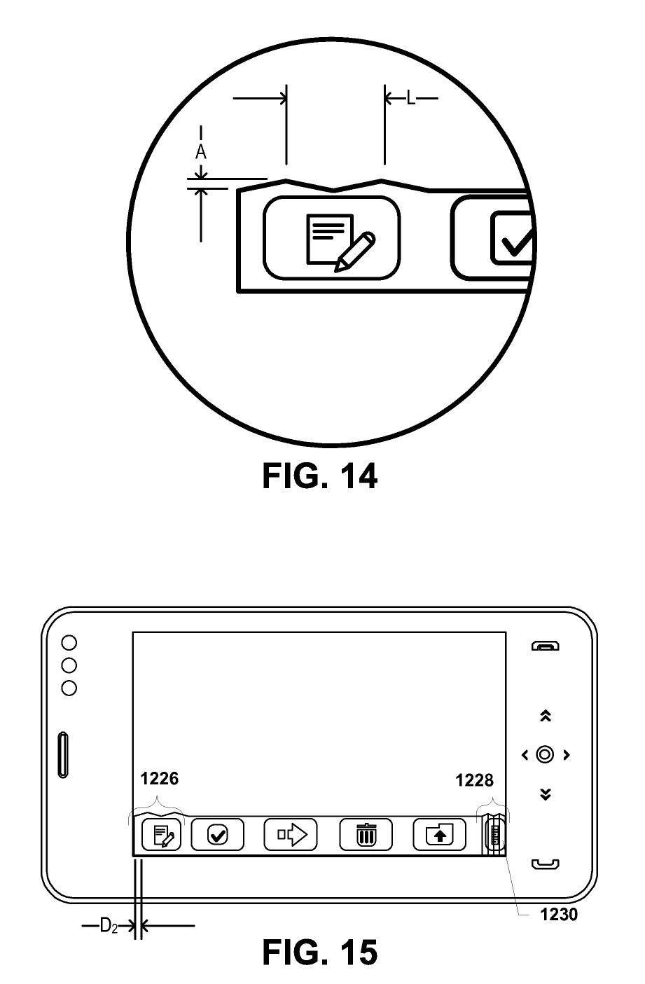

FIG. 14 illustrates the initial wrinkled portion 1224 in detail. As shown, the initial wrinkled portion 1224 may be a waveform having a generally triangular shape. Further, the initial wrinkled portion 1224 may have an amplitude, A, and a wavelength, WL.

As the GUI object menu 1200 continues to move to the left, as indicated in FIG. 15, when the exiting GUI object 1222 is within a second predetermined distance, D₂, of the left side 1216 of the display 1202, the left end 1206 of the GUI object menu 1200 may form a first intermediate wrinkled portion 1226 and the exiting GUI icon 1222 may begin to collapse. Further, the right end 1208 of the GUI object menu 1200 may form an initial unwrinkled portion 1228 and an entering GUI object 1230 may begin to expand into the GUI object menu 1200.

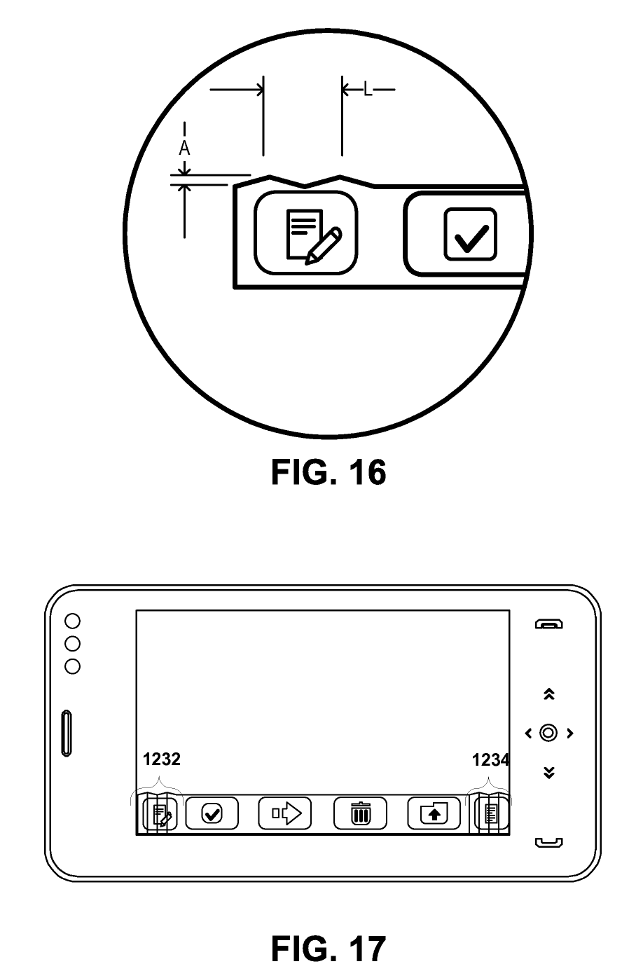

FIG. 16 illustrates the first intermediate wrinkled portion 1226 in detail. As shown, the intermediate wrinkled portion 1226 may be a waveform having a generally triangular shape. As shown in FIG. 16, the first intermediate wrinkled portion 1226 may have an amplitude, A, and a wavelength, WL. In a particular aspect, the amplitude of the first intermediate wrinkled portion 1226 may be substantially the same as the amplitude of the initial wrinkled portion 1224. Moreover, the wavelength of the first intermediate wrinkled portion 1226 may be less than the wavelength of the initial wrinkled portion 1224.

FIG. 17 illustrates that as the GUI object menu 1200 continues to move to the left, the exiting GUI object 1222 may continue to collapse and a second intermediate wrinkled portion 1232 may be formed on the left end 1206 of the GUI object menu 1200. Further, the entering GUI object 1230 may continue to expand and a first intermediate unwrinkled portion 1234 may be formed on the right end 1208 of the GUI object menu 1200.

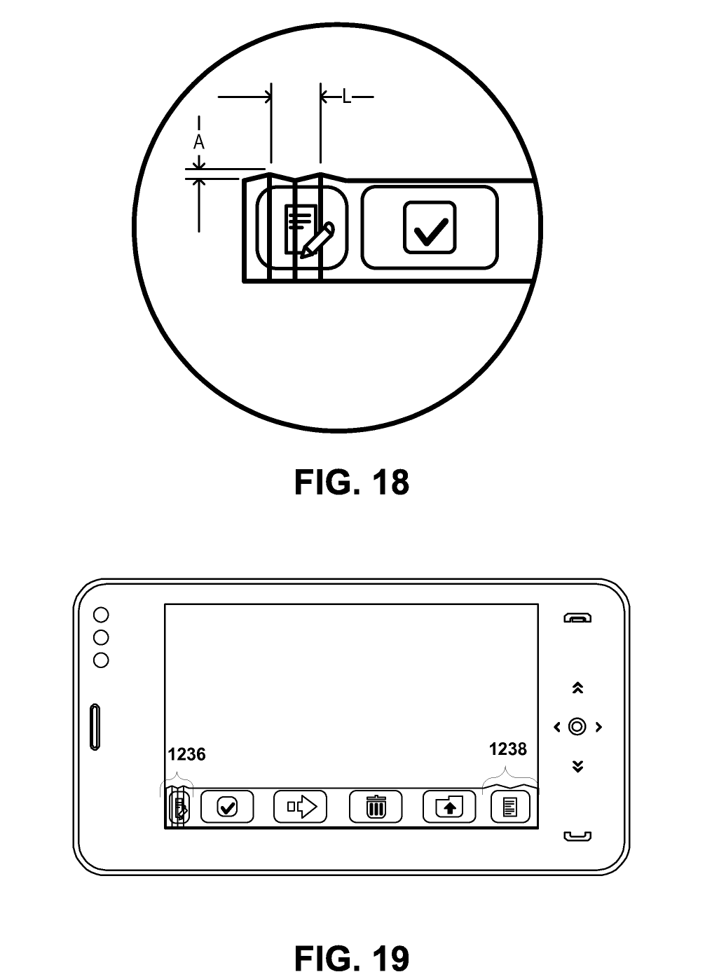

FIG. 18 depicts the second intermediate wrinkled portion 1232 in detail and indicates that the second intermediate wrinkled portion 1232 may be a waveform having a generally triangular shape. Moreover, FIG. 18 shows that the second intermediate wrinkled portion 1232 may have an amplitude, A, and a wavelength, WL. In a particular aspect, the amplitude of the second intermediate wrinkled portion 1232 may be substantially the same as the amplitude of the initial wrinkled portion 1224 and the amplitude of the first intermediate wrinkled portion 1228. The wavelength of the second intermediate wrinkled portion 1232 may be less than the wavelength of the first intermediate wrinkle 1226.

Referring now to FIG. 19, as the GUI object menu 1200 continues to move to the left, the exiting GUI object 1222 may continue to collapse and a third intermediate wrinkled portion 1236 may be formed. The entering GUI object 1230 may continue to expand and a second intermediate unwrinkled portion 1238 may be formed on the right end 1208 of the GUI object menu 1200.

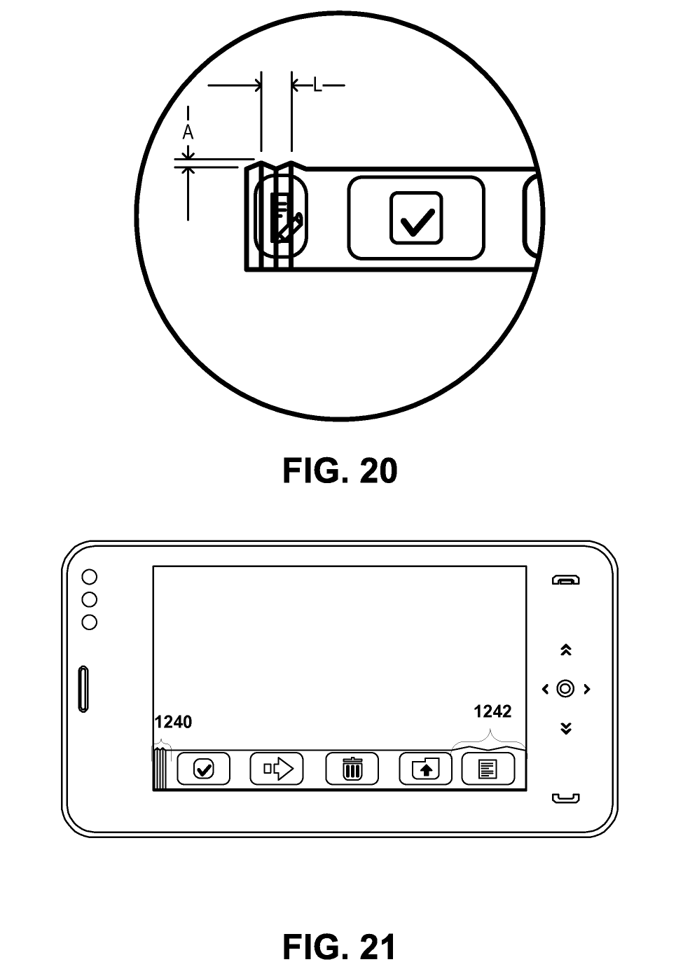

FIG. 20 shows the third intermediate wrinkled portion 1236 in detail. FIG. 20 indicates that the third intermediate wrinkled portion 1236 may be a waveform having a generally triangular shape. Also, FIG. 20 indicates that the third intermediate wrinkled portion 1236 may have an amplitude, A, and a wavelength, WL. In a particular aspect, the amplitude of the third intermediate wrinkled portion 1230 may be substantially the same as the amplitude of the initial wrinkled portion 1224, the amplitude of the first intermediate wrinkled portion 1226, and the amplitude of the second intermediate wrinkled portion 1232. The wavelength of the third intermediate wrinkled portion 1236 may be less than the wavelength of the second intermediate wrinkled portion 1232.

As the GUI object menu 1200 continues to move to the left, as indicated in FIG. 21, the exiting GUI object 1222 may collapse completely and disappear from the display 1202. Further, the left end 1206 of the GUI object menu 1200 may form a final wrinkled portion 1240. Also, the entering GUI object 1230 may fully expand into the GUI object menu 1200 and a third intermediate unwrinkled portion 1242 may be formed on the right end 1208 of the GUI object menu 1200.

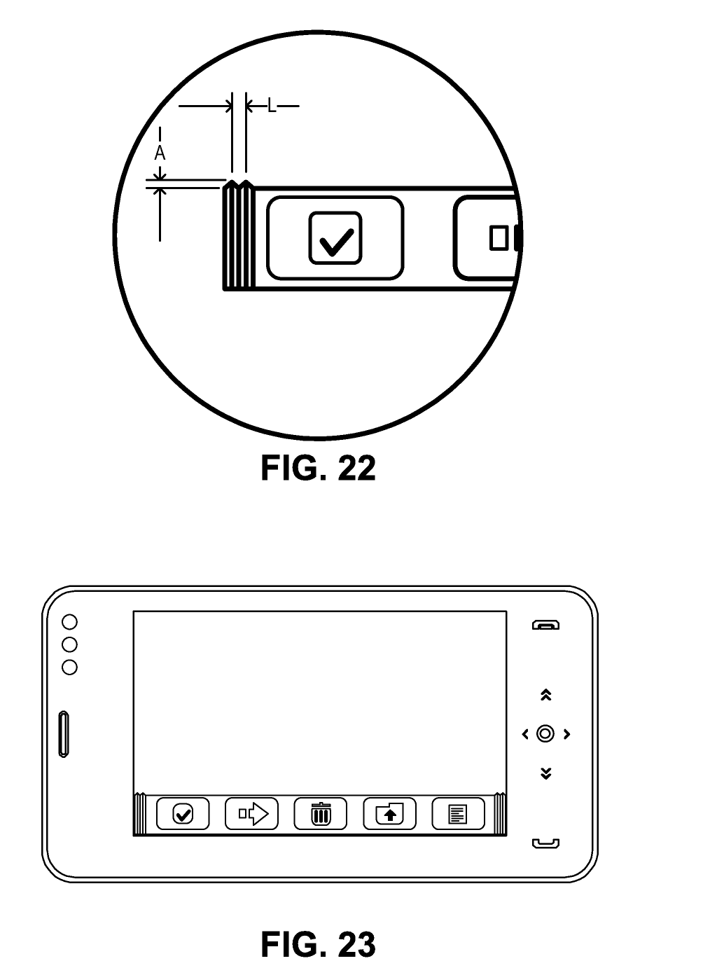

FIG. 22 shows the final wrinkled portion 1240 in detail. FIG. 22 indicates that the final wrinkled portion 1240 may be a waveform having a generally triangular shape. Also, FIG. 22 indicates that the final wrinkled portion 1240 may have an amplitude, A, and a wavelength, WL. In a particular aspect, the amplitude of the final wrinkled portion 1240 may be substantially the same as the amplitude of the initial wrinkled portion 1224, the amplitude of the first intermediate wrinkled portion 1226, the amplitude of the second intermediate wrinkled portion 1232, and the amplitude of the third intermediate wrinkled portion 1236. Further, the wavelength of the final wrinkled portion 1240 may be less than the wavelength of the third intermediate wrinkled portion 1236.

In a particular aspect, as illustrated in FIG. 23, when the exiting GUI object (not shown in FIG. 23) completely exits the GUI object menu 1200 (and the display 1202), the entering GUI object 1230 completely enters the GUI object menu 1200 (and the display 1202), and there are remaining GUI objects off screen to the right of the display 1202, the left end 1206 of the GUI object menu 1200 may include a final wrinkled portion 144. Further, the right end 1208 of the GUI object menu 1200 may include a final wrinkled portion 146. The final wrinkled portions 144, 146 on each end 1206, 1208 of the GUI object menu 1200 may indicate that there are GUI objects off screen to the left of the display 1202 and to the right of the display 1202.

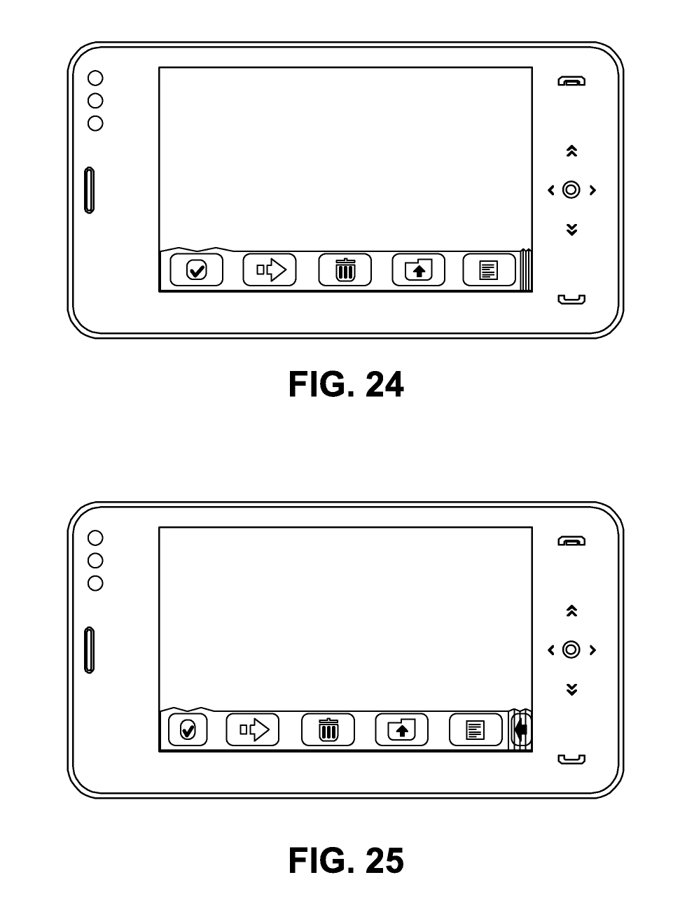

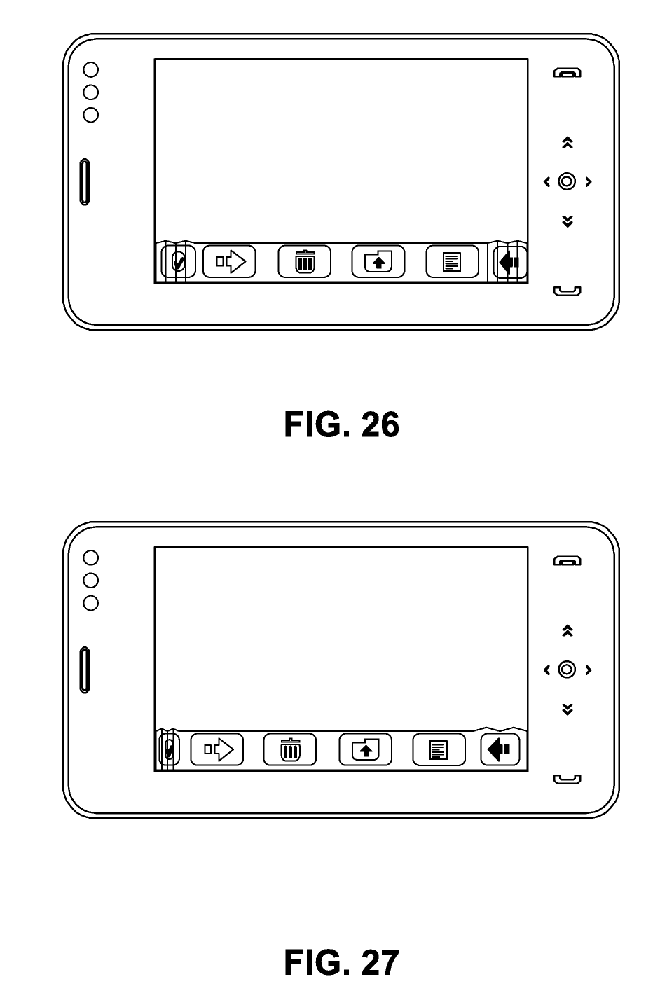

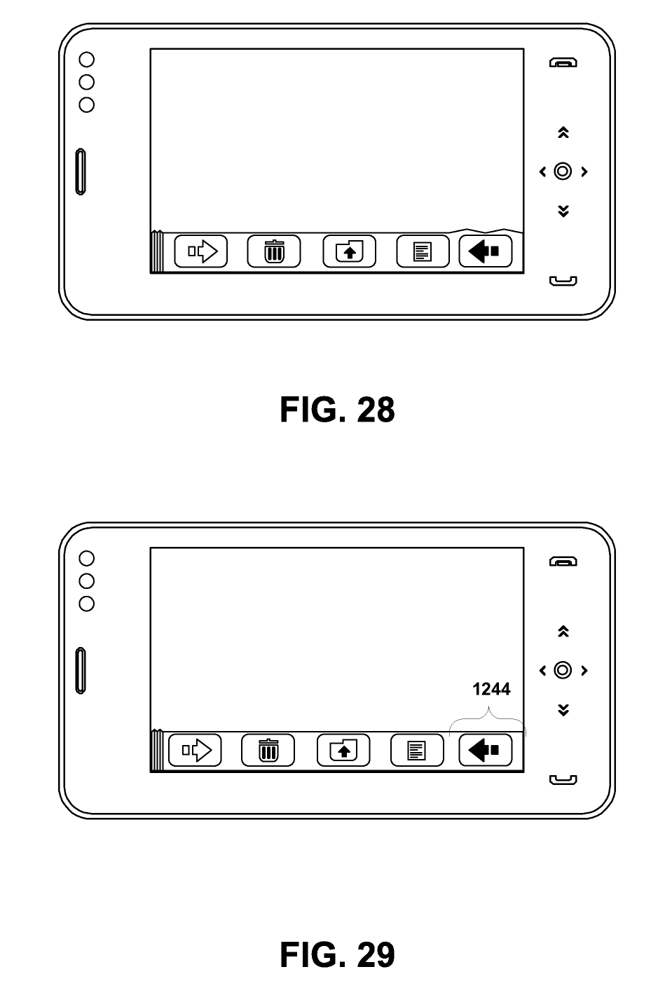

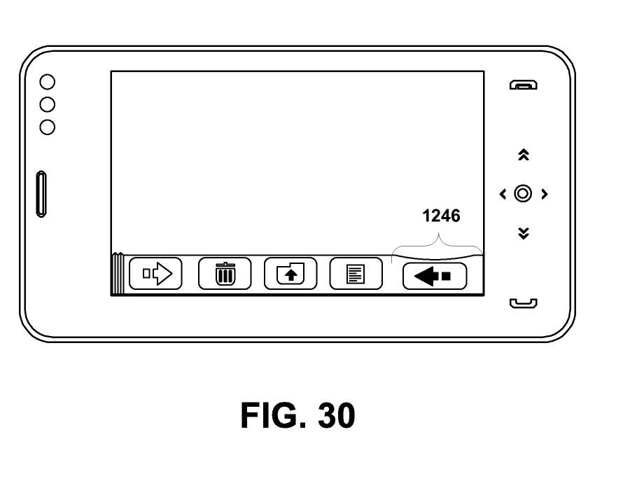

FIG. 24 through FIG. 29 show that a user may continue to move the GUI object menu 1200 to the left in the same manner as described herein. As the user continues to move the GUI object menu 1200 to the left, exiting GUI objects may collapse, entering GUI objects may expand, and the various wrinkled portions and unwrinkled portions on the GUI object menu 1200 may be displayed. When there are no more GUI objects available to the right of the display 1202, the right end 1208 of the GUI object menu 1200 may display a final unwrinkled portion 1244, as shown in FIG. 29. The final unwrinkled portion 1244 may indicate that there are not any more GUI objects available to the right of the display 1202. If a user continues to attempt to move the GUI object menu 1200 to the left, even though there are not any GUI objects available to the right of the display, the right end 1208 of the GUI object menu 1200 may form an unwrinkled, stretched portion 1246 as illustrated in FIG. 30. When the user releases the GUI object menu 1200, the right end 1208 of the GUI object menu 1200 may return to the final unwrinkled portion 1244 shown in FIG. 29. It may be appreciated that the final unwrinkled portion 1244 is also an unstretched portion.

In a particular embodiment, the initial unwrinkled portion 1224 is similarly sized and shaped as the third intermediate unwrinkled portion 1242. The first intermediate wrinkled portion 1226 is similarly sized and shaped as the second intermediate unwrinkled portion 1238. Moreover, the second intermediate wrinkled portion 1232 is similarly sized and shaped as the first intermediate unwrinkled portion 1234. The third intermediate wrinkled portion 1236 is similarly sized and shaped as the initial unwrinkled portion 1228. The difference between the various wrinkled portions and the unwrinkled portions is the final shape, e.g., a final wrinkled portion or a final unwrinkled portion, to which the wrinkled portion or unwrinkled portion leads.

FIG. 12 through FIG. 30 indicate the movement of the GUI object menu 1200 as a user swipes, or otherwise moves, the GUI object menu 1200 to the left. However, it may be appreciated that moving, or swiping, the GUI object menu 1200 to the right would cause the GUI object menu 1200 to move in the same manner, but in the opposite direction, e.g., starting at FIG. 29 and moving backwards through the FIGs to FIG. 12.

It is to be understood that the method steps described herein need not necessarily be performed in the order as described. Further, words such as “thereafter,” “then,” “next,” etc. are not intended to limit the order of the steps. These words are simply used to guide the reader through the description of the method steps. Moreover, the methods described herein are described as executable on a portable computing device (PCD). The PCD may be a mobile telephone device, a portable digital assistant device, a smartbook computing device, a netbook computing device, a laptop computing device, a desktop computing device, or a combination thereof.

The method disclosed herein provides one or more ways to display graphical user interface objects on a display. When a GUI object menu is display, either end of the GUI object menu may be wrinkled. The wrinkle may indicate that one or more GUI objects may be available off screen on the same side of the display as the wrinkled end of the GUI object menu. If the GUI object menu is wrinkled on both ends, GUI objects may be available off screen on each side of the display. If an end of the GUI object menu is unwrinkled, no GUI objects may be available off screen on the side of the display corresponding to the unwrinkled end of the GUI object menu.

In a particular aspect, the GUI object menu may be moved in a first direction and a second direction that is opposite the first direction. Om a particular aspect, the first direction may be left and the second direction may be right. In another aspect, the first direction may be right and the second direction may be left. In yet another aspect, the first direction may be up and the second direction may be down. In still another aspect, the first direction may be down and the second direction may be up. In another aspect, the first direction may be forward and the second direction may be backward. In another aspect, the first direction may be backward and the second direction may be forward. In yet another aspect, the first direction may be at an angle and the second direction may be one hundred and eighty degrees (180°) from that angle, e.g., the first direction may be at an angle equal to forty-five degrees (45°) and the second direction may be at an angle equal to two hundred twenty-five degrees (225°).

In one or more exemplary aspects, the functions described may be implemented in hardware, software, firmware, or any combination thereof. If implemented in software, the functions may be stored on or transmitted over as one or more instructions or code on a computer program product such as a machine readable medium, i.e., a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of displaying graphical user interface objects, the method comprising:
displaying a GUI object menu on a display; and
displaying a wrinkled portion at at least one an end of the GUI object menu.

2. The method of claim 1, wherein the wrinkle indicator indicates one or more GUI objects are available off screen at an edge of the display adjacent to the wrinkle indicator.

3. The method of claim 2, further comprising:
determining whether the GUI object menu is moved.

4. The method of claim 3, further comprising:
determining a direction of motion if the GUI object menu is moved, wherein the direction of motion comprises a first direction and a second direction opposite the first direction.

5. The method of claim 4, further comprising:
determining whether one or more GUI objects are available off screen in the second direction, when the GUI object menu is moved in the first direction.

6. The method of claim 5, further comprising:
displaying an unwrinkled portion on an end of the GUI object menu corresponding to the second direction, when one or more GUI objects are not available off screen in the second direction.

7. The method of claim 6, further comprising:
displaying an unwrinkled, stretched portion on the end of the GUI object menu corresponding to the second direction, when an attempt to continue to move the GUI object menu in the first direction is made.

8. The method of claim 5, further comprising:
designated a GUI object nearest an edge of the display corresponding to the first direction as an exiting GUI object, when one or more GUI objects are available off screen to the second direction.

9. The method of claim 8, further comprising:
monitoring a location of the exiting GUI object.

10. The method of claim 9, further comprising:
wrinkling the end of the GUI object menu corresponding to the first direction when the exiting GUI object is within a first predetermined distance of an edge of the display corresponding to the first direction.

11. The method of claim 10, further comprising:
collapsing the exiting GUI object when the exiting GUI object is within a second predetermined distance of the side of the display corresponding to the first direction.

12. The method of claim 11, further comprising:
unwrinkling the end of the GUI object menu corresponding to the second direction.

13. The method of claim 12, further comprising:
designating a GUI object off screen in the second direction as an entering GUI object.

14. The method of claim 13, further comprising:
expanding the entering GUI object into the GUI object menu.

15. A wireless device, comprising:
means for displaying a GUI object menu on a display; and
means for displaying a wrinkled portion at at least one an end of the GUI object menu.

16. The wireless device of claim 15, wherein the wrinkle indicator indicates one or more GUI objects are available off screen at an edge of the display adjacent to the wrinkle indicator.

17. The wireless device of claim 16, further comprising:
means for determining whether the GUI object menu is moved.

18. The wireless device of claim 17, further comprising:
means for determining a direction of motion if the GUI object menu is moved, wherein the direction of motion comprises a first direction and a second direction opposite the first direction.

19. The wireless device of claim 18, further comprising:
means for determining whether one or more GUI objects are available off screen in the second direction, when the GUI object menu is moved in the first direction.

20. The wireless device of claim 19, further comprising:
means for displaying an unwrinkled portion on an end of the GUI object menu corresponding to the second direction, when one or more GUI objects are not available off screen in the second direction.

21. The wireless device of claim 20, further comprising:
means for displaying an unwrinkled, stretched portion on the end of the GUI object menu corresponding to the second direction, when an attempt to continue to move the GUI object menu in the first direction is made.

22. The wireless device of claim 19, further comprising:
means for designated a GUI object nearest an edge of the display corresponding to the first direction as an exiting GUI object, when one or more GUI objects are available off screen to the second direction.

23. The wireless device of claim 22, further comprising:
means for monitoring a location of the exiting GUI object.

24. The wireless device of claim 23, further comprising:
means for wrinkling the end of the GUI object menu corresponding to the first direction when the exiting GUI object is within a first predetermined distance of an edge of the display corresponding to the first direction.

25. The wireless device of claim 24, further comprising:
means for collapsing the exiting GUI object when the exiting GUI object is within a second predetermined distance of the side of the display corresponding to the first direction.

26. The wireless device of claim 25, further comprising:
means for unwrinkling the end of the GUI object menu corresponding to the second direction.

27. The wireless device of claim 26, further comprising:
means for designating a GUI object off screen in the second direction as an entering GUI object.

28. The wireless device of claim 27, further comprising:
means for expanding the entering GUI object into the GUI object menu.

29. A wireless device, comprising:
a processor, wherein the processor is operable to:
display a GUI object menu on a display; and
display a wrinkled portion at at least one an end of the GUI object menu.

30. The wireless device of claim 29, wherein the wrinkle indicator indicates one or more GUI objects are available off screen at an edge of the display adjacent to the wrinkle indicator.

31. The wireless device of claim 30, wherein the processor is further operable to:
determine whether the GUI object menu is moved.

32. The wireless device of claim 31, wherein the processor is further operable to:
determine a direction of motion if the GUI object menu is moved, wherein the direction of motion comprises a first direction and a second direction opposite the first direction.

33. The wireless device of claim 32, wherein the processor is further operable to:
determine whether one or more GUI objects are available off screen in the second direction, when the GUI object menu is moved in the first direction.

34. The wireless device of claim 33, wherein the processor is further operable to:
display an unwrinkled portion on an end of the GUI object menu corresponding to the second direction, when one or more GUI objects are not available off screen in the second direction.

35. The wireless device of claim 34, wherein the processor is further operable to:
display an unwrinkled, stretched portion on the end of the GUI object menu corresponding to the second direction, when an attempt to continue to move the GUI object menu in the first direction is made.

36. The wireless device of claim 33, wherein the processor is further operable to:
designate a GUI object nearest an edge of the display corresponding to the first direction as an exiting GUI object, when one or more GUI objects are available off screen to the second direction.

37. The wireless device of claim 36, wherein the processor is further operable to:
monitor a location of the exiting GUI object.

38. The wireless device of claim 37, wherein the processor is further operable to:
wrinkle the end of the GUI object menu corresponding to the first direction when the exiting GUI object is within a first predetermined distance of an edge of the display corresponding to the first direction.

39. The wireless device of claim 38, wherein the processor is further operable to:
collapse the exiting GUI object when the exiting GUI object is within a second predetermined distance of the side of the display corresponding to the first direction.

40. The wireless device of claim 39, wherein the processor is further operable to:
unwrinkle the end of the GUI object menu corresponding to the second direction.

41. The wireless device of claim 40, wherein the processor is further operable to:
designate a GUI object off screen in the second direction as an entering GUI object.

42. The wireless device of claim 41, wherein the processor is further operable to:
expand the entering GUI object into the GUI object menu.

43. A computer program product, comprising:
at least one instruction for displaying a GUI object menu on a display; and
at least one instruction for displaying a wrinkled portion at at least one an end of the GUI object menu.

44. The computer program product of claim 43, wherein the wrinkle indicator indicates one or more GUI objects are available off screen at an edge of the display adjacent to the wrinkle indicator.

45. The computer program product of claim 44, further comprising:
at least one instruction for determining whether the GUI object menu is moved.

46. The computer program product of claim 45, further comprising:
at least one instruction for determining a direction of motion if the GUI object menu is moved, wherein the direction of motion comprises a first direction and a second direction opposite the first direction.

47. The computer program product of claim 46, further comprising:
at least one instruction for determining whether one or more GUI objects are available off screen in the second direction, when the GUI object menu is moved in the first direction.

48. The computer program product of claim 47, further comprising:
at least one instruction for displaying an unwrinkled portion on an end of the GUI object menu corresponding to the second direction, when one or more GUI objects are not available off screen in the second direction.

49. The computer program product of claim 48, further comprising:
at least one instruction for displaying an unwrinkled, stretched portion on the end of the GUI object menu corresponding to the second direction, when an attempt to continue to move the GUI object menu in the first direction is made.

50. The computer program product of claim 47, further comprising:
at least one instruction for designated a GUI object nearest an edge of the display corresponding to the first direction as an exiting GUI object, when one or more GUI objects are available off screen to the second direction.

51. The computer program product of claim 50, further comprising:
at least one instruction for monitoring a location of the exiting GUI object.

52. The computer program product of claim 51, further comprising:
at least one instruction for wrinkling the end of the GUI object menu corresponding to the first direction when the exiting GUI object is within a first predetermined distance of an edge of the display corresponding to the first direction.

53. The computer program product of claim 52, further comprising:
at least one instruction for collapsing the exiting GUI object when the exiting GUI object is within a second predetermined distance of the side of the display corresponding to the first direction.

54. The computer program product of claim 53, further comprising:
at least one instruction for unwrinkling the end of the GUI object menu corresponding to the second direction.

55. The computer program product of claim 54, further comprising:
at least one instruction for designating a GUI object off screen in the second direction as an entering GUI object.

56. The computer program product of claim 55, further comprising:
at least one instruction for expanding the entering GUI object into the GUI object menu.
